(19) United States
(12) Patent Application Publication
(10) Pub. No.: US 2014/0365910 A1
(43) Pub. Date: Dec. 11, 2014

(54) SYSTEMS AND METHODS FOR SHARING AND SWITCHING BETWEEN PERSONAS ON MOBILE TECHNOLOGY PLATFORMS

(71) Applicant: Cellrox, Ltd., Tel Aviv (IL)

(72) Inventors: Oren LAADAN, New-York, NY (US); Offir GONEN, Ramat Hasharon (IL); Alexander Edward VAN'T HOF, New-York, NY (US); Amir GOLDSTEIN, Tel-Aviv (IL)

(73) Assignee: Cellrox, Ltd., Tel Aviv (IL)

(21) Appl. No.: 14/465,184

(22) Filed: Aug. 21, 2014

Related U.S. Application Data
(63) Continuation of application No. PCT/IL2013/050153, filed on Feb. 20, 2013.
(60) Provisional application No. 61/602,880, filed on Feb. 24, 2012.

(51) Int. Cl. G06F 3/0482; G06F 3/0484

(52) U.S. Cl. CPC G06F 3/0482; G06F 3/04842
USPC 715/747

(57) ABSTRACT

A method and system for sharing programs among first and second personas on a mobile technology platform equipped with a display. The method includes providing a first software application; in response to a user's launch of the first application in either the first persona or the second persona, starting the first application in a third persona; and in response to the user's launch of the first application in either the first persona or the second persona, switching the user from a persona of origin to the third persona, wherein the persona of origin is the persona in which the user launched the first application, wherein the first and second personas are defined as a set of user preferences associated with an operating system of the mobile technology platform.

### CROSS-REFERENCE TO RELATED APPLICATIONS

This application is a continuation application of international application No. PCT/IL2013/050153, filed on Feb. 20, 2013, which claims the benefit of U.S. Provisional Application No. 61/602,880, filed on Feb. 24, 2012, the contents of which are incorporated herein by reference.

### FIELD OF THE DISCLOSURE

The present disclosure relates generally to mobile technology platforms and, more particularly, to systems and methods for distributing and sharing applications among personas on a mobile device.

### BACKGROUND OF THE DISCLOSURE

Mobile technology platforms, including mobile communications devices and mobile computing devices, are used in various settings for various purposes. Frequently, it is desirable for the user of such a device to adopt various roles or “personas” while using the device. For example, the user may be utilizing the device for both personal and business use and, thus, has the need to switch between these personas.

In light of the foregoing, some systems have been developed to allow users to switch between different personas. For example, U.S. Pat. No. 7,086,008 (hereinafter “Capps et al.”) discloses computer systems which may adopt one of many personas depending upon the role that the user is currently undertaking. The computer system includes a central repository of extensible personas available to all applications running on the computer system. Each such persona has associated therewith a suite of parameters, or specific values for parameters, which are appropriate for conducting transactions in the name of their particular persona.

The computer system of Capps et al. further provides a graphical user interface which allows the user to switch from persona to persona by simply selecting a particular persona from a list of available personas on a display. By selecting a persona, the user causes the computer system to globally change the entire suite of parameter values so that subsequent transactions conducted with the computer system employ the parameter values of the currently selected persona.

In preferred embodiments of the system of Capps et al., the suite of parameters representing a given persona can be extended by applications running on the computer system. Specifically, various applications may add certain persona-specific parameters to the system's personas as required.

Capps et al. also discloses various techniques for changing the current persona adopted by the computer system. In accordance with one such technique, the user is allowed to select one of the personas listed on the display menu or on the list described above. Capps et al. notes that, in a pen-based computer system, this is preferably accomplished by determining when a user has tapped with a stylus on a displayed persona. In another technique disclosed in Capps et al., the current persona is determined by (1) identifying a password input by the user; (2) matching the password to one of the multiple personas available on the computer system; and (3) specifying, as the current persona, the persona which is matched to the password in the previous step.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an illustration of the components of a base system in accordance with an embodiment.

FIG. 2 is an illustration of a method for implicit switching of personas in accordance with an embodiment.

FIG. 3 is an illustration of a method for sharing personas in accordance with an embodiment.

FIG. 4 is an illustration of a method for sharing personas (no data) in accordance with an embodiment.

FIG. 5 is an illustration of a method for sharing service personas in accordance with an embodiment.

FIG. 6 is an illustration of a method for the partial sharing of service personas in accordance with an embodiment.

FIG. 7 is an illustration of a method for implementing a sharing cloud persona in accordance with an embodiment.

FIG. 8 is an illustration of a method for implementing a sharing sync persona in accordance with an embodiment.

FIG. 9 is an illustration of a method for implementing a software (SW) persona and a hardware (HW) persona in accordance with an embodiment.

FIG. 10 is a desktop view of an application distribution system which utilizes visual cues in the desktop view to represent the persona on which an application is installed or in which the application will be launched according to an embodiment.

FIG. 11 is a desktop view of an application distribution system which utilizes persona hot areas on the desktop view to which an application icon may be dragged so that the application will be launched with content and settings associated with the corresponding persona according to an embodiment.

FIG. 12 is a desktop view of an application distribution system which utilizes a persona selection interface, prompted by the selection of an icon that provides a means by which the user may choose the persona he would like to launch the application in according to an embodiment.

FIG. 13 is a desktop view of an application distribution system which utilizes a persona selection interface in which the selection items are based on predefined application settings set by the user according to an embodiment.

FIG. 14 is a desktop view of an application distribution system which utilizes persona application references, which are similar to shortcuts on a PC, to reference applications from other personas according to an embodiment.

FIGS. 15-17 are screenshots assigning an application reference to a particular persona according to an embodiment.

FIG. 18 is a desktop view illustrating a system for application distribution in which application distribution is achieved through the use of shared applications according to an embodiment.

FIGS. 19-21 are screenshots illustrating implementation of application sharing according to an embodiment.

### SUMMARY OF THE DISCLOSURE

In one aspect, a system and method are provided for a cross-persona-launch which may be implemented by selecting a cross-persona launch icon or menu item, through a sensor input or voice command, or by way of a suitable gesture. In these systems and methodologies, an icon, menu item, suitable gesture, voice command, or sensor input in one persona may launch the same or different application in another persona, and switch to that persona. The icon may be marked or tagged to indicate this behavior.

Possible examples of suitable gestures include, but are not limited to, finger gestures such as drawing of a circle on a touch screen, a long tap, or dragging an icon to a certain location. Possible sensor inputs include, but are not limited to, near-field communication (NFC) signals, Bluetooth® (BT) signals, radio frequency (RF) signals and infrared (IR) signals.

In another aspect, systems and methodologies are disclosed herein which allows switch-by-context (action) between personas. In these systems and methodologies, some applications on a mobile technology platform (referred hereinafter also as mobile devices merely for the sake of simplicity of the description) may launch other applications or activities in response to user actions, for example, tapping continuously on an entry in the mobile device logs may allow users to go to text-messaging. The user's actions and the related content are examined and compared against a set of rules and data. If a match is found, the corresponding application or activity is launched in a different persona, and the user is switched to that persona such that the persona in which the application is launched becomes an active persona.

In a further aspect, systems and methodologies are disclosed herein which allow switch-by-content) switching between personas. In these systems and methodologies, tapping on certain content type on a mobile device automatically launches a corresponding application or activity, for example, a uniform resource locator (URL) in a browser, or a phone number in an email). The selected content type is examined against a set of rules and data. If a match is found, the corresponding application or activity is launched in a different persona, and the user is switched to that persona (that is, the different persona becomes the active persona).

The foregoing aspect addresses instances in which a switch of personas occurs based on content or context. However, some of the disclosed embodiments are concerned with partial data sharing, in which data (or portions thereof) from one persona is made to appear in another persona, possibly with an indication of the origin of the data. One example of such data is contact information. Content-based or context-based switches between personas may be even more advantageous or intuitive.

In still another aspect, systems and methodologies are disclosed herein for indicating to users when an implicit switch to another persona has taken place, either before or immediately after the switch, thereby maintaining the user's awareness of his/her working context.

In yet another aspect, systems and methodologies are disclosed herein for sharing applications between personas by running a single instance of the application in a dedicated “sharing persona”. Launching a shared application from any persona (hereinafter, such launching personas referred to as “persona of origin”) will start the application in its dedicated sharing persona, and switch to that persona. Awareness indicators, such as the status bar color and icon, as well as the user's customized settings and profile (such as wallpapers, screen timeout settings, and the like), may appear as if the persona of origin is running, thereby providing transparency such that the user may not notice the switch. Exiting the application, or switching to another application, will resume the persona of origin.

Sharing in these systems and methodologies may be limited to specific personas by setting application icons to launch into one sharing persona or another. Also, some aspects of the indicators (and/or the user's customized settings) may intentionally appear different if, for example, there is a need to indicate that the user is operating in a shared persona.

Switching between personas in these systems and methodologies may occur while in a shared persona. Such switching will preferably change the effective persona of origin. Thus, for example, if a user has two personas A and B, and the user enters the shared persona from persona A (the persona of origin), a switch between personas (for example, by tapping an icon) will make persona B the new persona of origin and will change the context to persona B, thereby making the awareness indicators and the user's customized settings appear as if persona B is running.

In yet another aspect, systems and methodologies are disclosed herein for sharing of a single instance of an application among multiple “users”, each with his/her own data store (as used here, the term “users” may refer to the same person acting under different and separate personas). Launching an application from any persona will bind the data from that persona to the sharing persona, start the application in the sharing persona, and cause a switch to the sharing persona. Awareness indicators such as status bar colors and icons, as well as the user's customized settings and profile (such as wallpapers, screen timeout settings, etc.), may appear as if the persona of origin is running, thereby providing transparency such that the user may not notice the switch. Exiting the application, or switching to another application, will resume the persona of origin. Launching the same application from another persona concurrently will first close the existing instance, bind the data from the new persona in the sharing persona in place of the previous one, start the application in the sharing persona, and cause a switch to the sharing persona.

In various embodiments, sharing may be limited to specific personas by setting application icons to launch into one sharing persona or another.

Switching between personas may occur while in a shared persona. Thus, if a user has two personas A and B, and the user enters the shared persona from persona A (the persona of origin), a switch between personas (for example, by tapping an icon) will make persona B the new persona of origin and will change the context to persona B, thereby making the awareness indicators and the user's customized settings appear as if persona B is running. Also, some aspects of the indicators (and/or user's customized settings) may intentionally be made to appear different if there is a need to indicate that the user is operating in a shared persona.

In yet another aspect, systems and methodologies are disclosed herein for providing a common data store for data that is to be shared between personas. In some embodiments, access to the data may be abstracted in each persona through the use of proxies. Access to the data may be restricted according to suitable access policies. In other embodiments, data may be shared via a shared file or directory that is made visible or accessible to the respective application in each persona.

In still other embodiments, data may be shared by way of data proxies that intercept the access to the data (whether the access is to a file or a database) and perform a suitable remote procedure call (RPC) to read or write the information to or from either a central service or a service in the other persona.

In still further embodiments, data may be shared via shared content providers that implement standard services in the mobile system (such as the contacts store or calendar events store). The system then uses such services to obtain or put data, and the services may delegate the requests to a central service or to a service in the other persona. It will be appreciated that, in this embodiment, the content provider does not intercept all attempts to access the resource (that is, the content provider does not virtualize the resource). Rather, the content provider registers as a special purpose content provider alongside the other content providers that may exist.

In another aspect, systems and methodologies are disclosed herein for storing global device settings (for example, the device settings of a host mobile technology platform) in a shared persona. Calls to read or modify settings (e.g., within the mobile operating system framework, e.g., the Android™ framework) may be redirected using proxy logic to a service in the sharing persona.

In a further aspect, systems and methodologies are disclosed herein for implementing a general purpose data, service, or state (hereinafter referred to individually as an object, and collectively as objects) publishing mechanism that may be used between different personas. Applications may publish data by indicating the object type, object properties, object access control, and the actual object to share. The object may be filtered before passing it on to the publishing mechanism. Object type refers to the contents of the data such as, for example, the contacts and emails.

In some embodiments, object properties may be utilized to define the sharing behavior such as, for example, the expiration time for the object or whether the object is persistent data. Object access controls may be utilized to define which other personas (or classes of personas) can view, modify or, use the published object, as well as whether the object can expire, be updated by the publisher, or be revoked by the publisher. The object access controls may be defined, for example, by the administrator of a managed persona or by the user. In some embodiments, the object access controls may be defined for a user by an administrator via a management system.

An application can request an object by querying for an object of a certain type. Preferably, only applications from authorized personas will have access to the object. In an embodiment, a persona may be authorized at the time of publication by the persona of origin via, e.g., an input from the user of the persona of origin granting authorization to a persona. This query may be utilized, for example, to implement shared contacts where the work persona only reveals a portion of the object per contact.

In some embodiments, the manner in which data or a state is presented to the user may also be persona dependent. Thus, for example, the data or state may be presented “as is,” i.e., showing the contacts of both personas, or may be presented with an indication of the persona of origin. Similarly, in some embodiments, authorization may depend on the persona of origin, the persona that wishes to access the object, the object type, or various other parameters such as, for example, the time of day and other sensors, or the content of the object.

Published object data may also carry some metadata containing information about the origin of the data such as, for example, the persona, service or process of origin, or credentials. The metadata may also indicate the context of the “caller” in the original environment, and may be used, for example, to exercise permission checking in the target environment.

In yet another aspect, systems and methodologies are disclosed herein which extend the previous methodology by adding a “callback handler” property to object. If a callback handler property is defined and an object query cannot be satisfied with data stored by the shared-service, the service invokes the callback handler. This callback handler runs in the application in the persona of origin. For example, for applications that rely on data stored in the cloud or on company servers, the callback handler may perform the actions that the application usually performs to bring the requested data from, for example, external sources such as cloud services or company servers. The callback handler may filter the data before handing it over to the sharing service, after which the sharing service may reply to the original query. The sharing service may therefore be viewed as a proxy to the application responsible for bringing or delegating the object. Callback handlers may also be used as a notification mechanism for the application in the persona of origin to be notified of access requests.

It will be appreciated from the foregoing that, in general, an object type may have a callback handler associated with it which is called whenever the object is accessed. The callback handler may be delegated to the respective application in the persona of origin and, if so designated, will run there. The callback handler may respond with more objects, which may be filtered.

The callback handler may request additional data from an application that relies on cloud data or company-backed data. In such uses, the callback handler may return the additional data. Further, the callback handler may allow the application of origin to be notified of requests to access data. In such uses, the callback may not return data, but may instead log the activity for audit or statistics.

In another aspect, systems and methodologies are disclosed herein for implementing a service for synchronizing accounts and data. For each account or data type that can be synchronized, the service imitates a cloud (synchronization, or “sync”) service, but executes locally. Along with the sync service, an instance of the application that uses that data and which is connected to the actual service provider in the cloud is also run. Applications of this type which run in a user's personas and which rely on syncing to the service provider are configured to sync instead with the “local cloud” shared service. This mechanism leverages the application's native logic to synchronize its data with the “local cloud” in the sharing persona and, through that local cloud, with other instances of the application in other personas. Some non-limiting examples of data that may be synchronized in this manner include, but are not limited to, email, contacts, and calendar events.

In another aspect, a method may further comprise extending virtualization and separation approaches that facilitate multiple personas (e.g., ThinVisor™ or hypervisors) to support additional user space components, such as Bluetooth®. Such support may be achieved by running a single instance of the respective service and applications in a dedicated sharing persona, and by tunneling access from other personas through it.

In a further aspect, components of virtualization and separation approaches that facilitate multiple personas (such as, for example, ThinVisor™ or hypervisors) and that are running at the host area or control area to leverage the functionality and code base of mobile operating systems and environments may be allowed. Such operating systems and environments may include, but are not limited to, Java for Android™ environments and Objective C for iOS. These systems and methodologies feature a slim sharing persona that runs a simpler service to which the root zone can delegate work that is easily done there.

The foregoing systems and methodologies essentially move certain components that access hardware, for example, Bluetooth® or global positioning system (GPS) to a special “hidden persona”, and then delegate requests for hardware access from regular personas to that persona. Some such components are “standalone” and do not require any support environment. However, other such components require significant runtime support such as, for example, libraries, services, or other such resources. The special “hidden persona” may include such a runtime environment and, therefore, may leverage existing infrastructure rather than requiring such software to be rewritten to be used in the “hidden persona.”

In another aspect, systems and methodologies are disclosed herein for using a shared persona to provide a read-only persona which may be a duplicate of another private persona. When instantiated, access to data is typically restricted to read-only mode (e.g., via file system mount options), and users will not be able to alter or write to certain states of the persona (e.g., delete photos), but will still be able to access all of the data for viewing purposes.

One advantage of the read-only persona approach is that it does not require collaboration of the applications. If safety-catch functionality for the application was provided, it would be necessary to modify the framework of the mobile operating system (e.g., Android™) and have the service provider adopt the modification, or adjust each and every application to respect the safety-catch. Instead, the use of a dedicated persona works transparently for all applications, without necessitating changes to them. In other words, read-only functionality may be implemented in different ways, including by modifying the operating system (e.g., Android™) framework and ensuring that all applications adapt to this change in order to perform properly. However, such an approach is unreasonable given the large amount of applications already released and the nature of such a framework (which is usually unmodified by most virtualization and separation approaches). By contrast, the present approach avoids the issue and does not require collaboration of an application (or libraries), because it sets the proper staging for the applications—maintaining transparency and compatibility.

It will be appreciated that, technically speaking, the foregoing aspect behaves to make certain portions of the persona read-only. In particular a mobile operating system (e.g., Android™) typically needs and expects a set of writable locations, thereby making it undesirable or infeasible to make the entire persona read-only. Hence, according to various disclosed embodiments, the read-only attribute is assigned only to portions of interest of the persona such as, for example, data directories (e.g., of a photo gallery application or email application), configurations, and settings.

In yet another embodiment, systems and methodologies are disclosed herein for generating dedicated personas for scratch use, after which the personas may be discarded. Such sandbox personas may be instantiated explicitly by user request, or implicitly in response to contextual triggers.

In another aspect, systems and methodologies are disclosed herein for optimizing speed and memory use by using a copy-on-write mechanism in applications. In particular, the first instance of an application maybe started in a dedicated persona. The second instance of the application may reuse the first instance, and so on, as long as the usage remains read-only. When the usage patterns changes in a way that would alter the state of the application, the system will automatically instantiate a private copy of the application inside the user's persona of origin, and all changes will affect this private copy rather than the shared copy.

### DETAILED DESCRIPTION

The foregoing aspects, systems, and methodologies may be implemented, in whole or in part, through the use of suitable software or programming instructions which are recorded in a non-transitory (preferably tangible), computer readable medium. When implemented by a computer, the software or programming instructions may implement these aspects, systems, and methodologies or portions thereof.

As used herein, the term “persona” refers to an execution environment which may comprise a set of user preferences associated with a user identity document (ID), and which govern the operation of an operating system (OS). Multiple personas may be defined, for example, by an information technology (IT) administrator, a policy of the OS or the user in the systems and methodologies defined herein through, for example, the use of a suitable hardware virtualization technique, such as a virtual machine manager (VMM) or “hypervisor”. A hypervisor may be utilized, for example, to allow multiple operating systems to run concurrently on a host device, where it presents a virtual operating platform to the guest operating systems and manages the execution of those operating systems.

There are two main types of hypervisors currently known to the art, namely, Type 1 (or native, bare metal) hypervisors, and Type 2 (or hosted) hypervisors. Type 1 hypervisors run directly on the host's hardware to control the hardware and to manage the guest operating systems. Hence, the guest operating systems run on another level above the hypervisor. Examples of Type 1 hypervisors include Citrix XenServer, VMware ESXi, and Microsoft Hyper-V. Type 2 hypervisors run within a conventional operating system environment as a distinct second software level, with the guest operating systems running at a third level above the hardware. Examples of Type 2 hypervisors include KVM and Virtualbox. As used herein, the term “hypervisor” includes both Type 1 and Type 2 hypervisors.

While the system of U.S. Pat. No. 7,086,008 (Capps et al.) may be suitable for its intended purpose, further improvements are needed with respect to the implementation of multiple persona paradigms on mobile technology platforms.

Some of these needs and improvements are addressed in commonly assigned PCT/US12/62497 (Gonen et al.), entitled “Systems and Method for Implementing Multiple Personas on Mobile Technology Platforms”, which was filed on Oct. 27, 2011, and which is incorporated herein by reference in its entirety. There, various systems and methodologies are described which relate to the user-experience on a mobile device having a user interface with two or more personas that a user interacts with. Principles and mechanisms are disclosed which relate to four fundamental user-experience topics, namely, (a) awareness, (b) notifications, (c) switching, and (d) sharing. However, while these systems and methodologies represent a significant advance in the art, the focus there was on “explicit” user interaction with an operating system or device.

In particular—and though not necessarily limited in this regard—the systems and methodologies disclosed in commonly assigned U.S. Ser. No. 11/282,246 (Gonen et al.) were primarily focused towards situations in which users are explicitly aware of the different personas, and where switching between them involves an explicit action on the part of the user. Likewise, sharing was also explicit in the sense that it required specific mechanisms (which might be somewhat ad-hoc, and which didn't consider sharing of services or states) for each application or data type. Thus, for example, sharing was premised on one mechanism (or set of mechanisms) for the settings of a mobile device, and another mechanism (or set of mechanisms) for alarm applications. However, there is a need in the art for such systems and methodologies which are based on, or which leverage, implicit interactions with the user of the mobile device.

The shortcomings of the existing art may be met with the systems and methodologies and various embodiments disclosed herein. The utilization of implicit interaction in some of these systems and methodologies disclosed herein provides at least two important benefits. First of all, it reduces the awareness burden on users by automating the switch operation between personas depending on context and usage. Secondly, it generalizes the underlying sharing mechanisms by making them more structured and transparent to applications.

Other needs in the art may be met through systems and methodologies and embodiments described herein, including those embodiments that leverage special-purpose personas. Such special-purpose personas may include, but are not limited to: (a) a read-only persona, to allow a sort of “guest mode”; (b) a sandbox persona, to experiment with settings or applications; (c) a sharing persona, to allow robust transparent application sharing; and (d) a shadow persona to allow, for example, a ThinVisor™ to use the Android™ framework. It should be noted that the special purpose personas described herein are broadly applicable to various virtualization/sandbox methodologies implemented on various operating systems. Each of these special-purpose personas is described in greater detail below.

As noted above, the systems and methods disclosed in Gonen et al. were primarily concerned with multiple persona systems in which the user consciously chooses to switch between personas. Such switching may be accomplished, for example, by tapping or swiping the switch icon. However, systems and methodologies are disclosed herein in which switching may take place implicitly, and may depend on the user activity and/or on context. As a non-limiting example, tapping on a specially crafted application icon in the private persona may launch a corresponding application in the work persona. Here, the switch occurs in response to the user's action.

As another non-limiting example, when a user attempts to open a URL (from a browser or any other source) while in one persona, it may be determined if the link matches a pattern and, if so, a new browser may be automatically opened in another persona. Here, the switch depends on the context of user's action, and particularly on the content.

In a further example, an email client may be configured so that it always presents all email accounts from all personas, regardless of the persona the client is currently running in. Then, when the user selects an account to view, a new instance of the email client may be launched in the corresponding persona (see the “cross-persona-account” embodiment described in greater detail below).

To date, other programs exist that have features that are similar in certain respects to some of the systems and methodologies disclosed herein. For example, the Parallels Desktop program for Macintosh® computers is an operating system virtualization program that allows users to run Windows and other operating systems within the Mac OS X. VMWare's FUSION 4™ “unity mode” and Kidaro's embedded “applications-in-vm” offer similar virtualization programs. However, the usage models reflected in these products do not apply to the mobile world, because current mobile technology platforms do not have multiple concurrent windows. Instead, the prevailing approach in such devices is to always present one foreground application to the user.

Furthermore, the foregoing approaches suffer from at least three other drawbacks that are exacerbated on mobile platforms: (a) slow launch times (especially with respect to the first instance of each program); (b) potential inability to access data across virtual machine (VM) barriers when related applications are executed in different VMs; and (c) possible hijacking of file extensions previously associated with an application, wherein such file extensions may become re-associated with an application inside one of the VMs.

### Sharing Personas

As noted above, Gonen et al. was primarily concerned with multiple persona systems in which the user consciously chooses to switch between personas. Consequently, in some disclosed embodiments, sharing of data across personas is not application agnostic, and requires changes to the application and/or the operating system (e.g., the Android™ framework) in order to work properly. These requirements may be avoided in some embodiments through the use of a new model for sharing using a dedicated “sharing persona”. Such a sharing persona may serve as an “associated zone” to host applications and data to be shared, or to host services for partial data sharing. The sharing persona is hidden, and (preferably) the user may not switch to it explicitly.

A primary use of sharing personas is to allow sharing of a single instance of an application (and its data) across multiple associated personas. An example of an application which may be shared among personas is the alarm clock application. Preferably, a shared application always runs inside a sharing persona, regardless of where the application was started. Hence, instead of running shared applications in a user's persona of origin, the system may implicitly auto-switch to the corresponding shared persona for as long as the application is in the foreground. Moreover, the system may keep the look and feel of the persona of origin so that the user need not be mindful of transitions (see “shared application”). The persona of origin is typically the persona which the user was viewing or otherwise accessing upon starting the application.

Another possible use of sharing personas is to allow multiple users to use the same application while allowing each user to keep his or her own data. This feature may be advantageous in that it may allow applications to be used by several users without re-installing (and buying) several instances of the same application. For example, each user of the video game Angry Birds™ Star Wars® may wish to track his or her own scores and progress. Desktops typically accommodate this need through the provision of home directories. However, current operating systems utilized in mobile technology platforms typically feature a single user and a single application onscreen. Consequently, mobile applications may not be aware or prepared for such sharing.

Using a dedicated sharing persona, such applications may be run with only a single instance of the application installed by binding this instance to the specific data contexts (e.g., to the contexts of different users) dynamically and on demand. When the user launches the application, the system will bind the data store to the sharing persona, start the application within the sharing persona, and then switch to the sharing persona. The foregoing is subject to the caveat that mobile applications are typically not designed to run two instances of an application, each with its own data area, concurrently. Therefore, if a second launch of the application occurs without exiting the first one, the system may be adapted to close the first instance of the application and unbind the data, prior to launch of the second instance of the application. This transition preferably occurs in a manner that is transparent to the user such that the user is not typically aware of the change.

### Sharing Services

Another possible use of sharing personas is to host services for the sharing of application and data of a mobile device. For example, a sharing service may be used as a repository for a device's global settings (i.e., those settings that are explicitly shared between personas). These may include screen brightness, speaker volume, network settings, and the like. With the use of a sharing persona, access to the settings to be shared may be provided via a proxy mechanism in the framework that transparently redirects reads and writes of settings values to the sharing service, rather than using a local database in each persona.

A sharing service may also be utilized as a vehicle to allow applications to partially share data across personas. For example, it is frequently useful to share the contact name associated with a phone number so that, for example, incoming calls are recognized correctly, while other contact details are hidden. The sharing service may operate to expose an application program interface (API), which applications may utilize to publish data to be shared. When publishing data, an application may indicate the data type (e.g., contact information) and the permissions that dictate which personas can access the data (e.g., only managed personas, or all but insecure personas). In this way, an application may decide what data it will publish, and to whom. In particular, application data may first be filtered (e.g., so that only the name of a contact is exposed).

The API may also be utilized as a means for accessing the shared data. To request shared data, an application will preferably tell the server the data type and, if permitted for that persona, will get back the relevant data. Some data may be too large to fit on a device and may need to be fetched from an external source. For example, contact lists of large companies may be too long, and may require a query to the company server-side. Such data will preferably not be shared directly because it is not stored in full on the device and, even if it could be stored, it would be too wasteful to duplicate it.

To accommodate the foregoing situations, the sharing service API may also allow applications to specify a callback handler for their data. When a request is made to the sharing service and the needed data is not found in the service's local store, the service may delegate the request to the application of origin by invoking the callback handler. The application, in response, may locate the data, locally or externally, filter the result if needed, and return the data to the sharing service, wherein the sharing device will reply to the original query.

Another sharing service may be a local synchronization (sync) server that resides on the device (in a sharing persona). Applications (from any persona) that have synchronizable accounts or data, such as a Google™ account, may sync such accounts or data with the local sync server instead of syncing directly with the respective service provider. This approach permits easy and transparent sharing and synchronizing of data managed by an external service between different personas. In particular, data stored in different personas may be auto-synchronized between the personas by leveraging the native sync capabilities of those personas without the need to modify applications or adjust the storage setup.

### HW/SW Sharing Persona

A dedicated sharing persona may be used to extend a virtualization architecture by hosting components in the user space that access the hardware rather than in a kernel. The software stack (and applications) that access the hardware may run in the sharing persona instead of in each persona. For example, the Bluetooth® protocol may be supported by running the actual Bluetooth® service and logic in a sharing persona while also storing the settings, status, and pairing passwords in that sharing persona. Other personas may obtain the settings and statuses, as well as interact with the hardware, through a proxy that will communicate with this persona.

A dedicated sharing persona may be used to simplify virtualization and management complexity by leveraging the native operating system (e.g., the Android™ operating system) infrastructure in place of developing proprietary components. Thus, such components may be allowed to reside at the “control” area below both personas to use software components and services that already exist in the operating system. This may be accomplished through the use of a service in a slim sharing persona to perform tasks inside the operating system environment (e.g., the Android™ Java environment) for the control area. For example, instead of replicating the SMS decoding logic that already exists in Android™ at the control area, this task may be delegated to the sharing persona that will use the native operating system libraries for that purpose (see “sharing-software”).

### Read-Only Persona

One useful capability for owners of mobile technology platforms is to switch the device into read-only mode when allowing friends and family to view some contents, such as one's photos or media. A read-only persona may be implemented as a dedicated persona that is a duplicate of an existing regular persona, but that does not allow alteration of the underlying stored data. The data of the existing regular persona may be bound prior to switching to the persona. Instantiation and switching may be accomplished either with a whole environment or on a per application basis. One advantage of this approach is that applications are not required to collaborate. Thus, such safety-catch functionality must otherwise be tailored in the operating system framework and per application.

### Sandbox Persona

It may be further desirable to provide a sandbox persona to run untrusted applications that a user may download from the market for a trial, or as a vehicle through which a user may experiment with different settings and configurations without worrying about restoring the original state. The user may be provided an option (which may take the form of, for example but not limited to, a checkbox or a gesture) to indicate that a subsequent action (e.g., download) requires sandboxing, or to indicate that sandboxing should occur automatically for all downloads (similar to how anti-virus works), wherein sandboxing is using such a sandbox persona to run an application or modify settings. In such an embodiment, upon determining that the user has opted to perform sandboxing, a new sandbox persona is initiated and downloading of an application may begin in the new sandbox persona.

### Persona Copy-on-Write

Some applications are “mostly read-only” by nature, such as news or weather reports. Such “mostly read-only” applications may be run in a shared persona to save both disk space and memory, even if the user indicated that the settings should not be shared. When the user starts a “mostly read-only” application, the shared instance in the shared persona may be used by default. However, when a user first changes the application settings or alters the default view, the application may be restarted in the user's persona of origin (e.g., the private persona), and will then switch to that persona in place of the shared one. The result is a copy-on-write (COW) mechanism for applications.

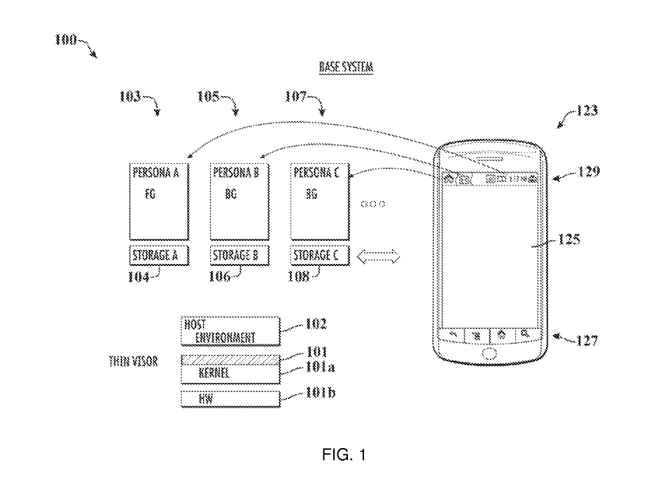

The foregoing systems and methodologies may be further appreciated and embodiments are further described herein below with respect to FIGS. 1-9. It should be noted that, while this embodiment will frequently be explained with respect to its implementation on an Android™ operating system, one skilled in the art will appreciate that the systems and methodologies described herein are not limited to any particular operating system.

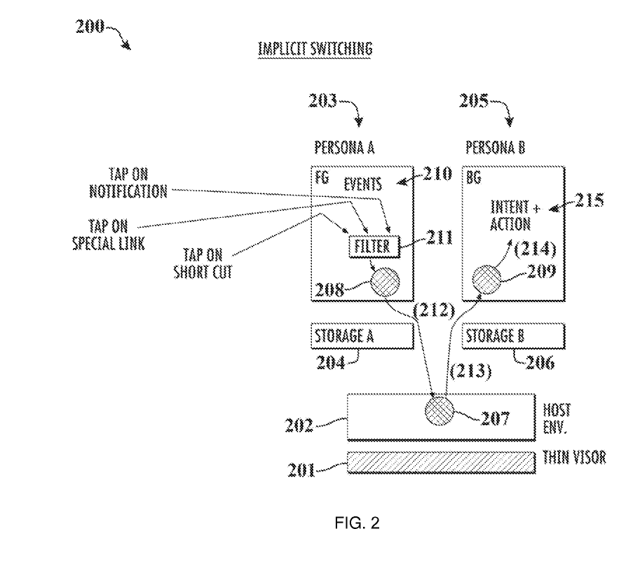

FIG. 1 of a base multi-persona system 100 for reference. The base system is intended as a reference to a generic multi-persona system, while FIGS. 2-9 are intended to show variations, additions and extensions of the base system.

The right side of FIG. 1 depicts the general appearance of one particular, non-limiting embodiment of a mobile technology platform in which the mobile technology platform is a mobile device 123. The mobile device 123 includes a display 125. A button region 127 with a plurality of buttons disposed therein is rendered on the bottom of the display 125, and a taskbar 129 is rendered at the top of the display 125.

The left-hand side of FIG. 1 provides a schematic overview of the multi-persona system 100. As seen therein, the taskbar 129 may include a foreground persona A 103, and at least one background persona such as, but not limited to, background persona B 105 and background persona C 107. Each persona may further be configured with a storage such as, for example, storage A 104, storage B 106, and storage C 108 associated with persona A 103, persona B 105, and persona C 107, respectively.

The system 100 includes hardware 101b (e.g., mobile device 123), a ThinVisor™ or hypervisor, user-space sandbox, user-space wrapper or other virtualization layer 101, and a host environment 102. The hypervisor 101 sits on top of a Linux or other kernel (the operating system of the mobile device 123) 101a. It should be noted that this arrangement is particular to the approach of virtualization in the embodiment depicted; more typically, a hypervisor actually sits beneath or instead of the kernel, and a user-space sandbox (a type of virtualization) sits on top of the host environment 102. The host environment 102 serves as the place where the control logic of the ThinVisor™, hypervisor, user-space sandbox, user-space wrapper, or other virtualization layer 101 runs, and may functions as a hardware persona for some services, and as a software persona for other services.

Each persona may also run a Service process (not depicted) that is responsible for communicating with the main Controller (also not depicted) running in the host environment 102. Such main Controller is responsible for proxying and routing messages between personas, and for switching the foreground persona A 103 to, e.g., a background persona. It is to be understood that, as used in the present context, the term, “process” refers to an instance of a computer program that is executed by a processor.

FIG. 2 illustrates a particular, non-limiting embodiment of a system 200 configured for implementing implicit switching in accordance with an embodiment. The system 200 depicted therein includes a foreground persona A 203 and a background persona B 205 with corresponding storage 204 and 206. The system 200 further comprises a host environment 202 and ThinVisor 201, which are as described in the embodiment of FIG. 1.

In addition to the base components, there is also a filter 211 that detects and intercepts certain conditions and events or “triggers” 210. When a trigger 210 is received, the filter 211 notifies a first Service process 208 of the foreground persona A 203. In response, the first Service process 208 sends a message 212 to a Controller 207, which forwards a command message 213 to a second Service process 209 of the background persona B 205. The command message 213 includes a request to launch an application or activity corresponding to the trigger. The second Service process 209 in response performs 214 the intended action 215, and the system 200 switches to using and/or displaying the background persona B 205.

The foregoing type of implicit switching is based on an explicit communication. In particular, the switching is based on explicit messages delivered through the Service in stances of personas (e.g., the first Service process 208 and/or the second Service process 209 of persona A 203 and persona B 205, respectively), and is executed by such instances. However, implicit switching may occur by way of an implicit mechanism as well, where messages from one persona (e.g., the foreground persona A 203) are routed (by means of a proxy) to another persona (e.g., the background persona B 205), without the explicit involvement of the first Service process 208 (or instance thereof) or the second Service process 209 (or instance thereof). Thus, some of these interactions may occur directly through the Controller 207 while skipping (that is, occurring without explicit intervention of) the first Service process 208 or the second Service process 209.

Various triggers and applications may be utilized including, but are not limited to, a tap on a user interface, a change in location of the host device, a voice activation, a change in availability of networks, a command from a remote server, and so on.

As a non-limiting example of a trigger, a tap on an inter-persona application shortcut may cause the launch of the application in another persona;

As another non-limiting example of a trigger, a tap on a URL of a certain pattern defined by the IT admin, e.g., in a browser, in a text message, or elsewhere, may launch a browser in the managed persona to open that link;

As yet another non-limiting example of a trigger, a tap on an inter-persona notification in the notification drawer may launch the notification drawer in another persona and display more details on the notification, as if it was inspected there;

As another non-limiting example of a trigger, an external data sensor may cause a switch in personas in response to, for example, the location of the host device, voice activation, availability of networks, a command from a remote server, etc.

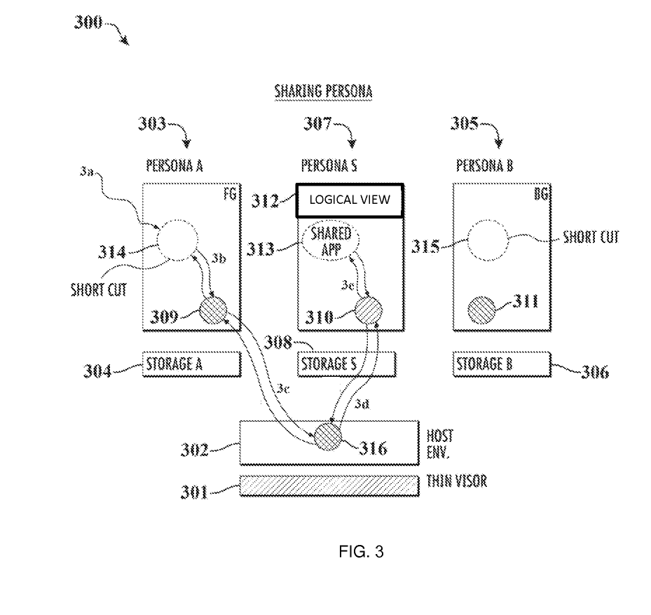

FIG. 3 illustrates a particular, non-limiting embodiment of a system 300 and methods thereof for implementing sharing personas in accordance with an embodiment. The system 300 includes a foreground persona A 303 and its associated storage A 304, a background persona B 305 and its associated storage B 306, and a sharing persona S 307 and its associated storage S 308. The system 300 further comprises a host environment 302 and ThinVisor 301, which are described in further detail herein above with respect to FIG. 1.

The sharing-persona S 307 hosts the applications which are to be shared among the other personas (e.g., applications to be shared among the foreground persona A 303 and/or the background persona B 305). Shared applications, such as shared app 313, may be accessed from any regular persona. Such shared applications are launched like regular applications, from the application-launcher view or from an application shortcut such as, for example, application shortcut 314 associated with the foreground persona A 303 and/or application shortcut 315 associated with the background persona B 305.

When a user, for example, taps 3a the application shortcut 314, it will message 3b a first Service process 309 of the foreground persona A 303, which will forward 3c the message to a Controller 316. The Controller 316 forwards 3d the message further to a second Service process 310 of the sharing persona S 307, which launches 3e the respective application and switch to the sharing persona S 307. It should be noted that the background persona B 305 is configured with a third Service process 311. The third Service process 311 is configured to operate as the second Service process 310 of the sharing persona S 307.

Because the sharing persona S 307 is intended to be shared, it does not present a separate context to the user. Instead, the sharing persona S 307 mimics the look and feel of the persona of origin as it was prior to the switch, and the user is typically unaware of the switch. To do so, the sharing persona S 307 maintains and presents a logical view 312 that is initialized to be the same as the originating persona (e.g., the foreground persona A 303). When the user exits the application (for example, by using the “home” key or the “back” key), it switches back to the persona indicated by the logical view 312.

When the user tries to switch personas or when a switch occurs implicitly by a the system 300 (it is to be understood both here, and elsewhere throughout this document wherever appropriate, that any reference to switching refers to switching which may occur by any of the methodologies described above), the system 300 may be configured to either exit the current shared application (e.g., shared app 313) and then switch to the other persona, or to remain in the current shared application but virtually switch to the other context by adjusting the logical view 312 to reflect the look and feel of the other persona.

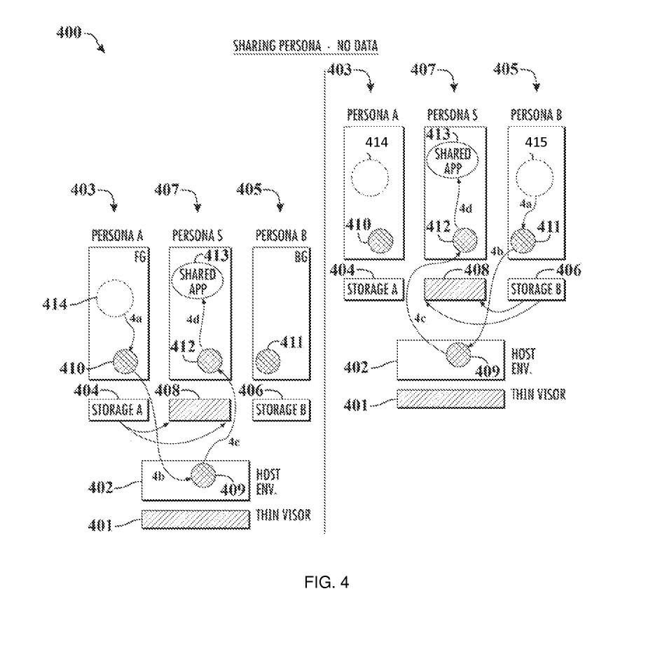

FIG. 4 illustrates a particular, non-limiting embodiment of a system 400 and methods thereof for implementing sharing personas respective of no-data-shared applications in accordance with an embodiment. The system 400 includes one foreground persona A 403 and its associated storage 404, one background persona B 405 and its associated storage 406, and one sharing persona S 407. According to an embodiment, the sharing persona S 407 has a virtual storage 408. The system 400 further comprises a host environment 402 and ThinVisor 401, which are described in further detail herein above with respect to FIG. 1. The sharing persona S 407 hosts applications to be shared among personas (e.g., the foreground persona A 403 and/or the background persona B 405).

Shared applications, such as shared app 413, may be accessed from any persona. They are launched like any applications from the application-launcher view or from an application shortcut such as, for example, application shortcut 414 associated with the foreground persona A 403 and/or application shortcut 415 associated with the background persona B 405. The purpose of a sharing persona S 407 is to share the application (e.g., shared app 413) but not its data (e.g., to save storage, or to avoid double payment). Thus, in this embodiment, sharing persona S 407 does not use its own data; instead, it uses data storage such as, but not limited to, storage 404 and/or storage 406 that belongs to the persona of origin (which may be, e.g., the foreground persona A 403 and/or the background persona B 405).

In the left side of FIG. 4, the user starts a no-data-shared application when a user, for example, taps the application shortcut 414 associated with the foreground persona A 403, will forward message 4a to a first Service process 410 which will forward message 4b to a Controller 409. Before forwarding the message to its destination, the Controller 409 will first mount the storage 404 of the origin persona application (the foreground persona A 403), or part of it, on to the virtual storage 408 of the sharing persona S 407. Mounting typically involves translating a virtual storage (e.g., virtual storage 408) in real-time such that the virtual storage may obtain access to another storage (e.g., storage A 404). Once ready, the Controller 409 will forward the message 4c further to a second Service process 412 of the sharing persona S 407, which will then launch 4d (e.g., the respective application) and switch to the sharing persona S 407.

In the right side of FIG. 4, the user starts the no-data-shared application when a user, for example, taps the application shortcut 415 associated with the background persona B 405, will forward message 4a to a third Service process 411 associated with the background persona B 405, which forwards the message 4b to the Controller 409. The Controller 409 will first stop the existing application instance, and remove the previous mount of the storage 404 of the previous persona (the foreground persona A 403). The Controller 409 will mount the storage 406 of the other persona (the background persona B 405), or part of it. Then the Controller 409 will forward the message 4c further to the Service process 412 of the sharing persona S 407, which will launch 4d (the respective application) and switch to the sharing persona S 407.

The sharing persona S 407 also maintains a logical view (not shown). When the user in this context tries to switch personas (or when a switch occurs implicitly), the Controller 409 will treat such view as if the application was launched in the persona being switched to.

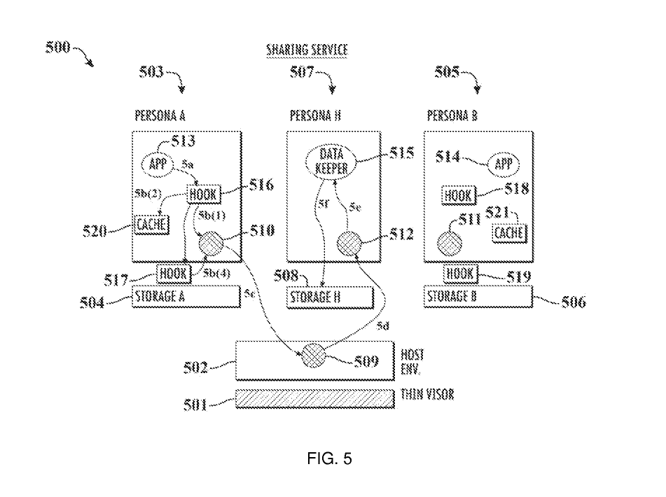

FIG. 5 illustrates a particular, non-limiting embodiment of a system 500 and methods thereof for implementing sharing service personas in accordance with an embodiment. The system 500 includes one foreground persona A 503 associated with a storage 504, one background persona B 505 associated with a storage 506, and one hidden persona H 507. The system 500 further comprises a host environment 502 and ThinVisor 501, which are described further herein above. The hidden persona 507 does not host applications usable or viewable by the user. Instead, it hosts programs providing shared services to other personas (the foreground persona A 503 and/or the background persona B 505). The hidden persona H 507 is typically never visible to the user, and may not be able to occupy the foreground.

The programs that may run in the hidden persona H 507 provide services to applications in the other personas (such as, e.g., the foreground persona A 503 and/or the background persona B 505), such as, but not limited to, data storage for common application settings, common device sharing, common phone calls log, and so on. Applications can request services explicitly or implicitly. An explicit request requires that the application use a suitable API to access the service. An implicit request involves intercepting the application's actions and delegating such actions to the designated service. For example, for applications settings store services, actions such as get/set settings maybe intercepted and forwarded to the respective service program.

Interception is implemented transparently and may be accomplished, for example, using special system hooks such as, for example, system hook 516 for the foreground persona A 503 and system hook 518 for the background persona B 505 to monitor application activity; or to file system hooks such as, for example, file system hook 517 for the foreground persona A 503 and file system hook 519 for the background persona B 505 to monitor file system activity; or by an automatic proxy (not shown) by the underlying messaging component of the system 500. This may be understood with reference, for example, to access to the application settings.

When an application such as, for example, application 513 in the foreground persona A 503 accesses 5a the data, either the system hook 516 or the file system hook 517 may intercept the access and forward the requests 5b(1) and 5b(4), respectively to a first Service process 510 associated with the foreground persona A 503. The first Service process 510 passes the request 5c to a Controller 509, which further passes the request 5d to a second Service process 512 associated with the hidden persona H 507. The second Service process 512 forwards the request 5e to a service program, such as, but not limited to, a data keeper 515, which performs the corresponding access 5f to its local storage 508. The result of the access is returned via the reverse flow path.

Because the round-trip to get/set data from/to the hidden persona H 507 may be non-negligible, each regular persona may additionally have a local cache, such as, for example, local cache 520 of the foreground persona A 503 or local cache 521 of the background persona B 505. The local cache may be configured to store 5b(2) the results of recent queries and use the cached data for subsequent queries, thereby avoiding overhead. The cache may be filled using read-ahead techniques, and its contents may be invalidated by a notification from the hidden persona H 507 (for example, when that data is modified by another persona).

The concept of interception was previously discussed in the context of data sharing, where the use of proxies was noted. Interception may also occur via proxying in the present context. However, in the present context, interception via proxying may not occur through a Service process; instead, it is routed directly to the proper service in the desired persona. If such proxying is involved, then the Service process may not be involved in the persona at the “receiving” side of the transaction.

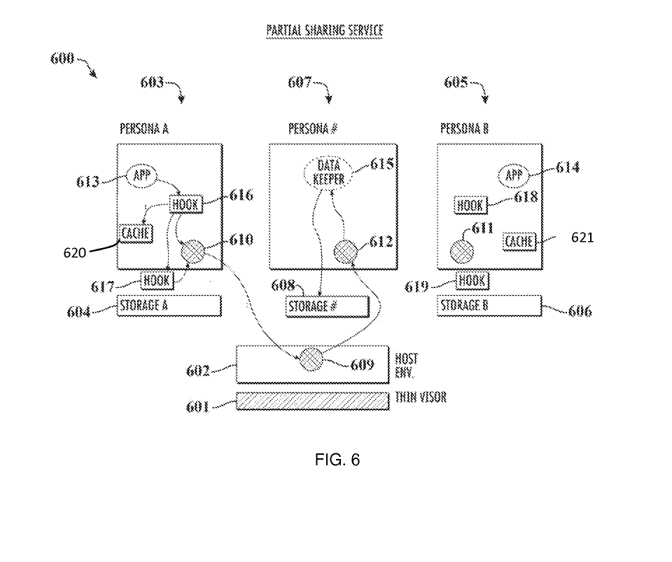

FIG. 6 illustrates an exemplary and non-limiting schematic diagram of a system 600 and method thereof for implementing partial sharing personas in accordance with the teachings herein. A partial sharing service persona 607 works similarly to a sharing service persona (e.g., persona H 507). That is, a partial sharing service may be as a central repository for applications such as, but not limited to, application 613 and/or application 614, from different personas such as, but not limited to, a foreground persona A 603 and/or a background persona B 605, respectively, to share data. In this embodiment, shared data is assigned a type and credentials. Personas, such as a foreground persona A 603 and/or a background persona B 605 are also given credentials. Each persona 603 and 605 exports data tuples such as, for example, data, type, cred, and the like. The credentials may indicate who can access the data. For example, access can be limited to one persona, all but one persona, and so on.

Each persona 603 and 605 may also have a “filter” component (not shown) attached to a Service process associated with each persona such as, for example, a first Service process 610 associated with the foreground persona A 603, a second Service process 611 associated with the background persona B 605, and a third Service process 612 associated with the partial shared persona 607. Each Service process 610 and/or 611 will inspect the data outgoing from its persona 603 or 605 to a data keeper 615 of the partial sharing service persona 607 and decide which data will be exported and with what credentials. When a persona 603 or 605 requests read or write access to a data tuple, the partial sharing service persona 607 will check the persona's 603 and/or 605 credentials against the data tuple and will grant access only when permitted.

It should be noted that the system 600 includes one storage 604 associated with the foreground persona A 603, one storage 606 associated with the background persona B 605, and a virtual storage 608 associated with the partial sharing persona 607. Each persona 603 and 605 may additionally have a local cache, for example, a local cache 620 of the foreground persona A 603 and a local cache 621 of the background persona B 605. The system 600 further comprises a host environment 602, a Controller 609, and ThinVisor 601. The components of the system 600 are described herein above.

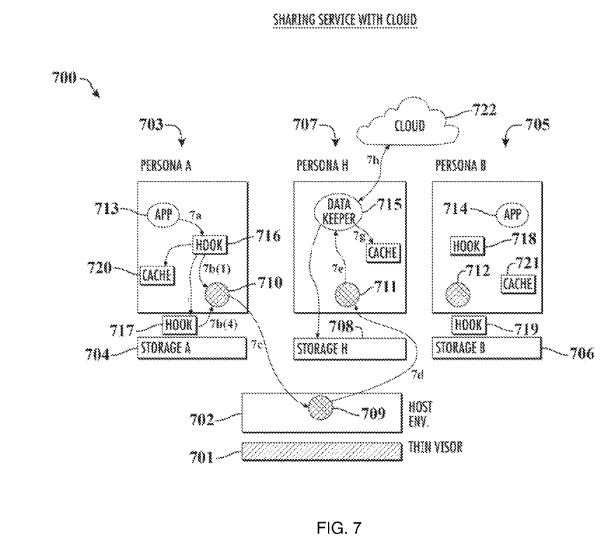

FIG. 7 illustrates a particular, non-limiting embodiment of a system 700 and method thereof for implementing a sharing cloud in accordance with the teachings herein. A sharing cloud persona, such as, persona H 707 may act (e.g., persona 607): as a central repository for applications (such as, e.g., application 713, application 714) from different personas, such as a foreground persona A 603 and/or a background persona B 605, to share data. It is useful when the original application 713 and/or 714 treats its local data as a cache for data stored in a cloud service. For example, the contacts application for a large enterprise only cache the most recently used contacts of the corporate wide contacts list, and an email client only keeps locally the most recent messages.

When the application 713 in a foreground persona A 703 accesses 7a local data, it will be intercepted by a system hook 716 or a file system hook 717 of the foreground persona A 703. The access will reach 7b(1) and 7b(4), and a first Service process 710 of the foreground persona A 703 will pass the foreground persona A 7037c to a Controller 709. From there, the foreground persona A 703 is passed 7d to a second Service process 711 on the sharing cloud persona 707. The second Service process 711 will pass 7e the foreground persona A 703 to the program service, e.g. a data keeper 715. The data keeper 715 will look for it locally, and if not found, will attempt to fetch 7h the foreground persona A 703 from a cloud 722. In this case, the sharing cloud persona 707 also keeps 7g a cache.

It should be noted that the system 700 includes one storage 704 associated with the foreground persona A 703, one storage 706 associated with the background persona B 705, and a virtual storage 708 associated with the sharing cloud persona 607. Each persona 703 and 705 may additionally have a local cache such as, for example, a local cache 720 of the foreground persona A 703 and a local cache 721 of the background persona B 705. The system 700 further comprises a host environment 702 and ThinVisor 701.

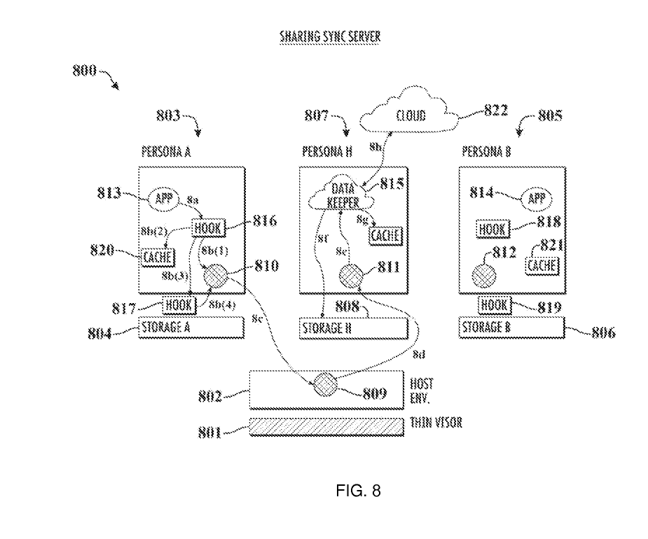

FIG. 8 illustrates a particular, non-limiting embodiment of a system 800 and methods thereof for implementing a sharing sync persona such as persona H 807 in accordance with an embodiment. The sharing sync persona H807 work very similarly to a sharing service persona (e.g., persona H 507): as a central repository for applications from different personas such as, but not limited to, persona A 803 and/or persona 805 to share data. In this embodiment, the program services that run inside the sharing sync persona H 807 provide standard sync services such as contacts sync, email sync, and so on. Applications such as application 813 in persona 803 and/or application 814 in persona 805 can be explicitly configured to sync against the local services. Applications 813 and/or 814 can also be programmed to synchronized against the local service, e.g., a first Service process 810 associated with persona A 803 or a second Service process 812 associated with persona B 805, by intercepting their network traffic.

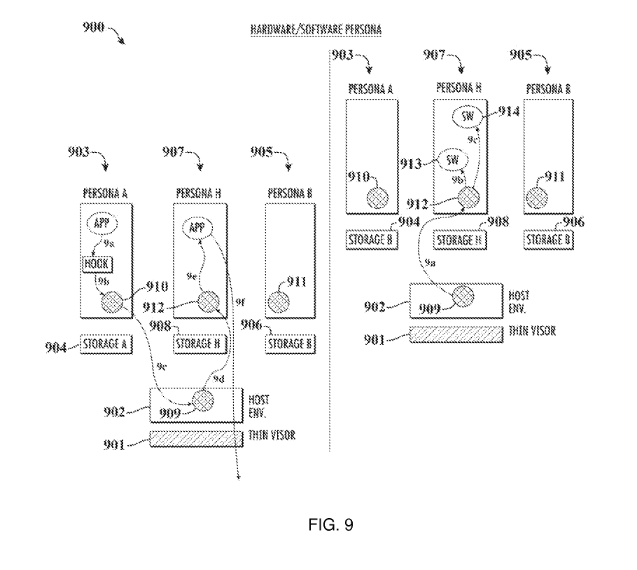

FIG. 9 illustrates a particular, non-limiting embodiment of a system 900 and methods thereof for implementing a software (SW) persona and a hardware (HW) persona in accordance with an embodiment. The left portion of FIG. 9 depicts a HW persona, HW persona H 907. The HW persona H907 is invisible to users and cannot become a foreground persona such as persona B 903. The HW persona H 907 can hosts programs and services that are responsible for interaction with the hardware. The corresponding facilities in regular personas, such as, the foreground persona A 903 and/or a background persona B 905, are replaced with hooks, such as, hook 903. Attempts to access the hardware in those personas are intercepted 9a (e.g. by the hooks or via proxying), and forwarded 9c to the HW persona H 907 via transfer 9b to a first Service process 910 of the foreground persona A 903, then forwarded 9d via a Controller 909, and then via 9e to a second Service process 912 of the HW persona 907. Actual hardware access only occurs in the second Service process 912, and the results are returned to the caller via the reverse path.

It should be noted that the foreground persona A 903 is associated with a storage 904, the background persona B905 is associated with a storage 906 and a third Service process 911, and persona H907 is associated with a virtual storage 908. In addition, the system 900 further comprises a host environment 802, and ThinVisor 801 which are as described in the embodiment of FIG. 5.

The right portion of FIG. 9 depicts a SW persona, such as persona H 907 containing SW programs such as SW programs 913 and 914. The SW persona 907 is invisible to users and cannot become the foreground persona 903. The SW persona 907 can host programs and services that may be used by the Controller 909. The main motivation to do so is in cases when the library or program for a certain task already exists (for example, the logic for deciphering text messages in the Android™ platform), but where it is undesirable to re-develop these resources to run in the host environment 902. Instead of re-writing the logic in the host environment 902, which is thinner and offers less programming support, with the SW persona H 907, it is possible to leverage existing code. This leverage not only reduces development costs, but also builds on mature and tested code, and lowers the maintenance burden respective of that code.

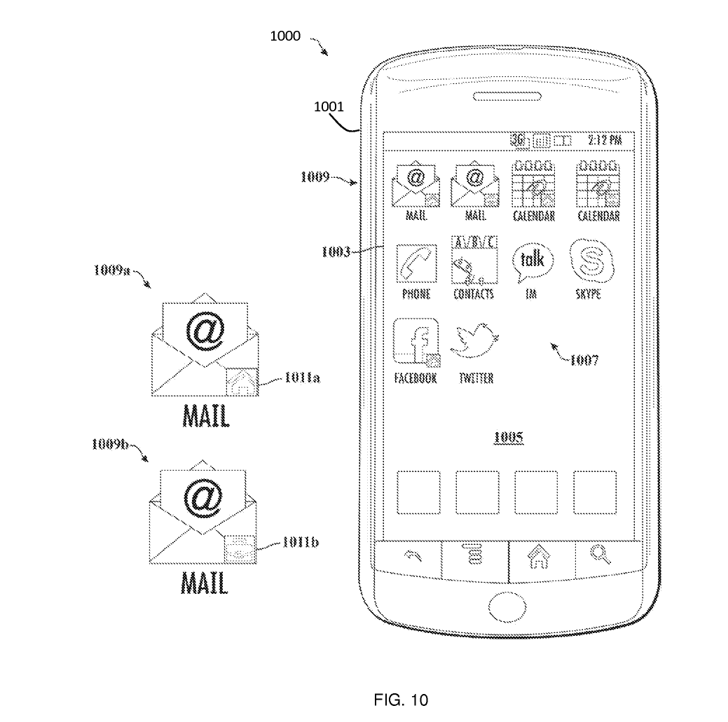

FIGS. 10-21 depict particular, non-limiting embodiments in accordance with the teachings herein for the distribution of applications across multiple personas according to various embodiments. While many variations of these embodiments are possible, it is preferable that the embodiments utilized satisfy the following requirements: (a) any application should have the ability to be launched from any persona; (b) applications can have exclusive content and state across different personas; and (c) an application can share content and state across personas.

With respect to FIG. 10, a particular, non-limiting embodiment of a system for application distribution is depicted with respect to its implementation on a mobile device 1001 equipped with a display 1003 configured for application distribution according to an embodiment. The display 1003 includes a single desktop view 1005 that features application icons 1007 that are installed on any persona. The desktop view 1005 itself is not attached to any persona. However, visual cues may be utilized in the desktop view 1005 to represent a persona on which an application is installed. Thus, for example, in the illustrated embodiment, icons 1009 corresponding to a user's email application include an indicia, for example, in the form of a sub-icon of a house 1011a or briefcase 1011b) which indicates whether the corresponding application relates to the user's business use persona 1009b or personal use persona 1009a.

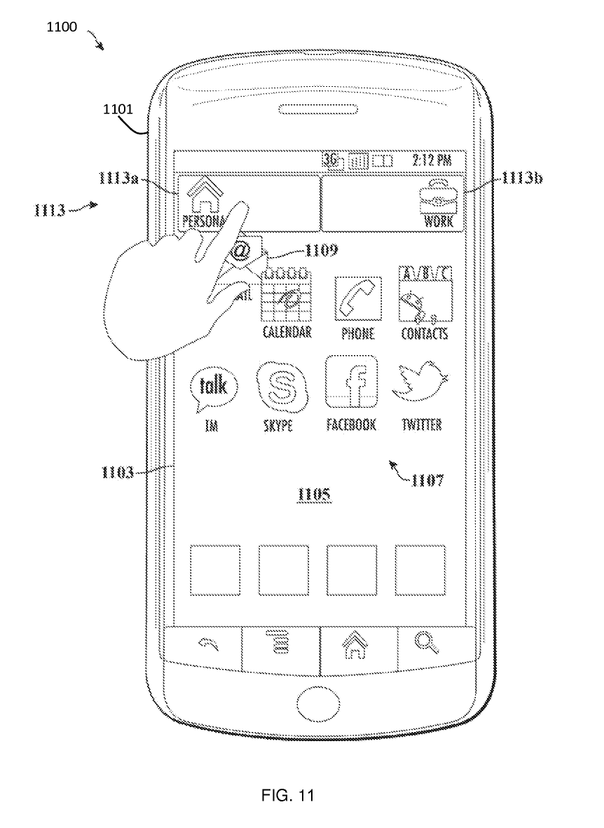

With respect to FIG. 11, another particular, non-limiting embodiment of a system for application distribution is depicted with respect to its implementation on a mobile device 1101 equipped with a display 1103. The illustrated embodiment includes a single desktop view 1105 that features application icons 1107 and persona hot areas 1109. When a user drags an application icon of the features application icons 1107 to a hot area 1113, an operating system or associated program launches the application corresponding to the application icon in the persona associated with the hot area 1113, and with the exclusive content associated with that persona.

Thus, for example, in the particular embodiment depicted in FIG. 11, the hot area 1113 is divided in to a personal hot area 1113a and a business hot area 1113b. Dragging an application icon for an email application 1109 into the personal hot area 1113a results in the application being launched with the user's personal settings and content, while dragging the application icon for the email application 1109 into the business hot area 1113b results in the application being launched with the user's business settings and content. Clicking the application icon while it is on the main area of the desktop 1105 (i.e., not in the hot area 1113) will launch the corresponding application with globally shared content and, possibly, in a shared persona. The desktop view 1105 is not attached to any particular persona.

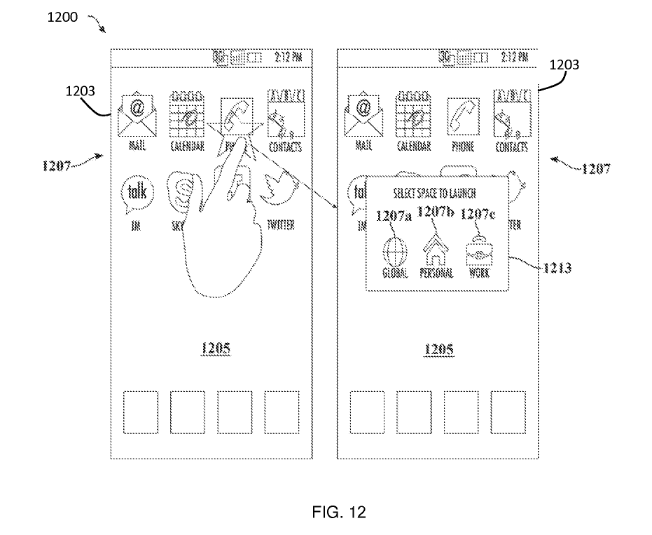

With respect to FIG. 12, another particular, non-limiting embodiment of a system 1200 for application distribution is depicted with respect to its implementation on a mobile technology platform (not shown) equipped with a display 1203. The illustrated embodiment includes a single desktop view 1205 that features application icons 1207. Clicking an application icon of the features application icons 1207 on the desktop view 1205 prompts the launch of a persona selection interface 1213. The persona selection interface 1213 permits a user may choose the persona he would like to launch the corresponding application in.

For example, the user may choose to launch the application in a personal persona environment 1207b or a business persona environment 1207c having business or personal settings and content associated there with, respectively, or the user may choose to launch the application in a global persona environment 1207a having global content and settings associated with it. The desktop view 1205 is not attached to any particular persona.

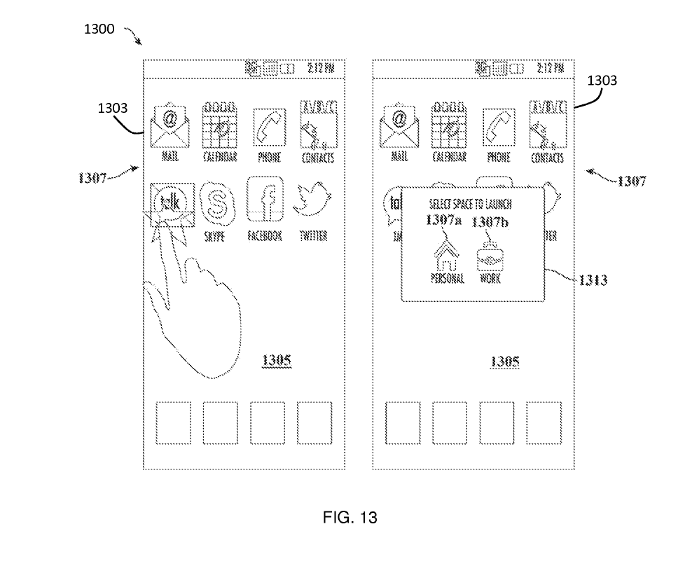

With respect to FIG. 13, another particular, non-limiting embodiment of a system 1300 for application distribution is depicted with respect to its implementation on a mobile technology platform (not shown) equipped with a display 1303. The illustrated embodiment includes a single desktop view 1305 that features application icons 1307. Clicking an application icon of the features application icons 1307 will prompt a persona selection interface 1313 in which a user may choose the persona (e.g., personal persona environment 1307a or business persona environment 1307b) he or she would like to launch the corresponding application in. The selection items are based on predefined application settings set by the user. The desktop view 1305 is not attached to any particular persona.

In some variations of the foregoing embodiment, an application icon of the features application icons 1307 may have different regions defined thereon which correspond to different personas (not shown), the selection of which causes the respective application to be launched in the corresponding persona. For example, an application icon may be split, with an upper half corresponding to a first persona and a lower half corresponding to a second persona (split icon not shown). This split may be manifested at all times, or may be manifested only when a cursor is placed over it. In another embodiment, the split may be manifested when the application icon is clicked a single time, with a second click on one of the regions causing the respective application to be launched in the persona corresponding to that number of clicks.

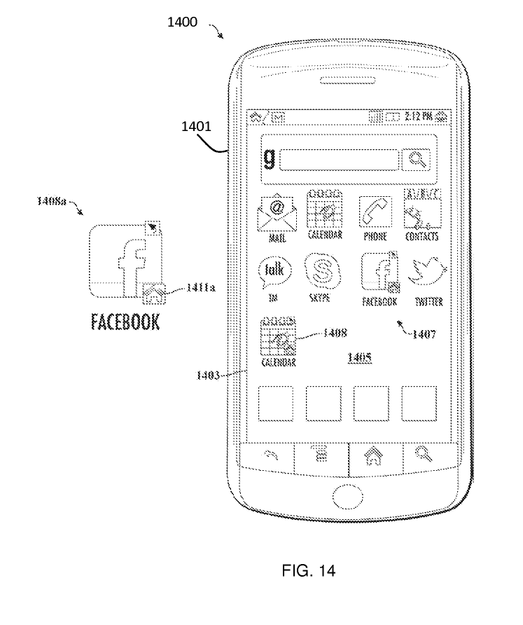

With respect to FIG. 14, another particular, non-limiting embodiment of a system 1400 for application distribution is depicted with respect to its implementation on a mobile device 1401 equipped with a display 1403. The illustrated embodiment includes a single desktop view 1405 that features application icons 1407. In this embodiment, every installed application in a persona has its own exclusive content associated with it. Persona application references 1408, which are similar to shortcuts on a personal computer (PC) and which reference applications from other personas, may be created. This allows applications from one persona environment to sit in another persona environment. Such sitting may allow a user to access applications from one persona environment while the mobile device is configured to display a different persona environment.

Visual cues 1411a on the application references 1408, such as application reference 1408a, may be utilized to portray the application, its reference type, and the referenced persona. For example, the visual cue may be an indicia, such as a home indicia 1411a which indicates that the application reference corresponds to a personal persona. Preferably, references can only be created on the desktop 1405.

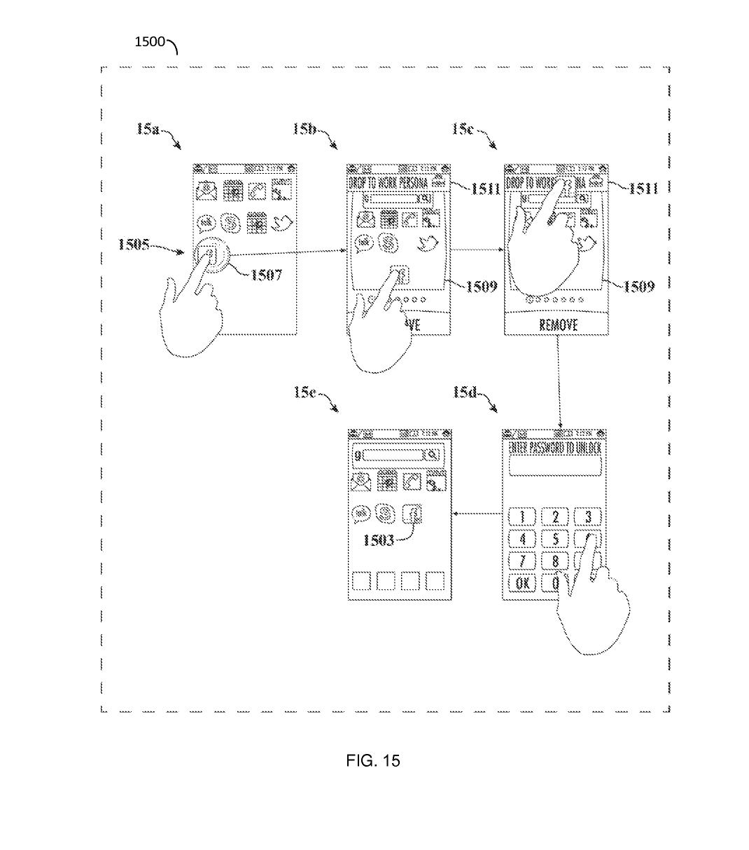

FIGS. 15-17 illustrate different particular, non-limiting embodiments of systems 1500 through 1700 and methodologies which may be utilized in accordance with the teachings herein to assign an application reference to a particular persona. Notably, the embodiments involve actions—such as icon selection, menu item selection, and password entry—to be formed in various sequences to complete the assignment. In these embodiments, interacting with the icon may take various forms, such as, but not limited to, a long press, a drag, and/or a gesture.

In the embodiment of FIG. 15, for example, in 15a, a user initiates a process for creating a shortcut 1503 by using a long press 1505 on an application icon 1507 corresponding to an application the user wishes to create a shortcut to. In 15b, the long press 1505 launches a menu 1509 from which the shortcut 1503 to be created may be associated with a particular persona. In this embodiment, the menu 1509 is equipped with an association toolbar 1511 which may be toggled among any number of personas (e.g., among a personal persona, a business persona, and so on).

In 15c, when the application icon 1507 is dragged to the association toolbar 1511, in 15d, a process is initiated that launches a security screen from which, in some embodiments, the user may be required to enter a password. Upon successful entry of the password, the process generates a shortcut 1503 to the application corresponding to the dragged application icon 1507, as seen in 15e. It should be understood that the shortcut 1503 is associated with the persona indicated in the association toolbar 1511 at the time the process was initiated. The resulting shortcut 1503, which may take the place of the selected application icon 1507, may be marked with a suitable indicia to indicate the persona it is associated with. Marking application icons with suitable indicia is described further herein above with respect to FIG. 10.

In some embodiments, a long press and drag to a hot area, either visible, invisible, or outside of the display, may either create a shortcut or switch to the target persona. Subsequently dropping the icon in the hot area of the other persona may create a shortcut to the application in that persona.

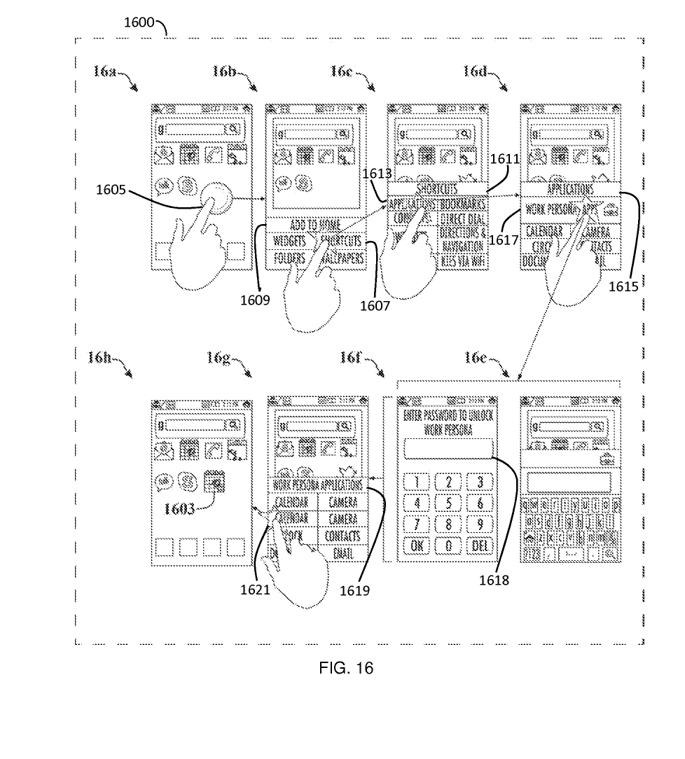

FIG. 16 illustrates another particular, non-limiting embodiment of a system 1600 and methodology which may be utilized to assign an application reference to a particular persona. In the particular system 1601 depicted, a long press 1605 launches a screen 1609 shown in step 16b from which a user may choose to create a shortcut 1603 to an application. In 16b, when the user selects the “shortcuts” tab 1607 from the menu, in 16c, the “shortcuts” tab 1607 expands into a shortcuts menu 1611 from which the user may select various attributes for the shortcut.

If the user selects the “applications” tab 1613 from this menu as depicted in 16c, the “applications” tab 1613 may expand into an applications menu 1615 as depicted in step 16d. From the applications menu 1615, the user may select a persona to associate with the shortcut. In the case depicted, in 16d, the user selects the “Work Persona Apps” menu item 1617, which, in 16e and in 16f, launches the screens from which the user is prompted to enter a password. After entry of the password, in 16g, the user is presented with a menu of applications 1619. In the case depicted, the user selects the “Calendar” tab 1621 from the menu of applications 1619, which generates the application shortcut 1603 as shown in step 16h. The resulting shortcut 1603, which may take the place of the selected application icon, may be marked with a suitable indicia to indicate the persona it is associated with. Marking application icons with suitable indicia is described further herein above with respect to FIG. 10.

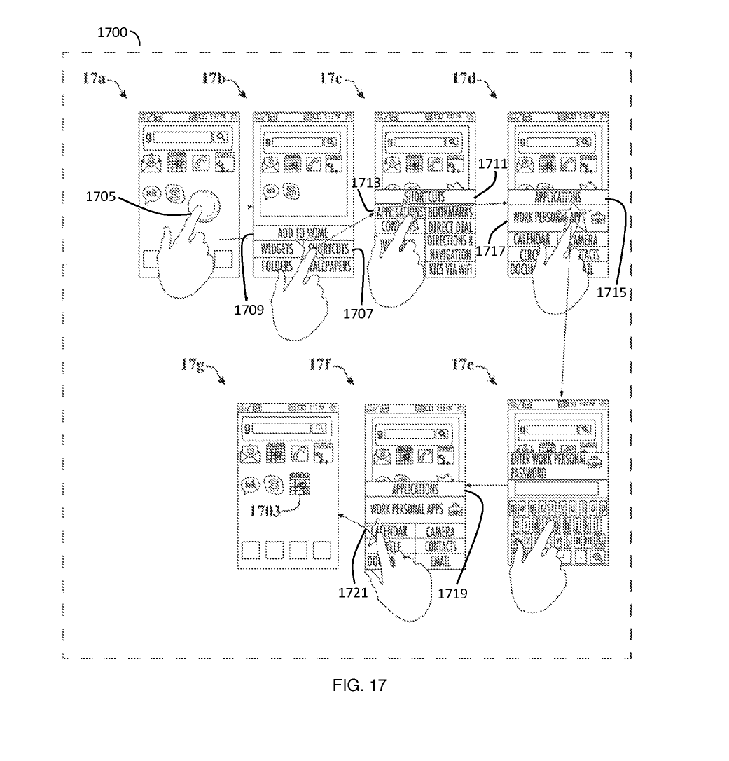

FIG. 17 illustrates another particular, non-limiting embodiment of a system 1700 and methodology which may be utilized to assign an application reference to a particular persona. In this embodiment, in 17a, a long press 1705 launches a screen 1709 from which a user may choose to create a shortcut to an application. In 17b, when the user selects the “shortcuts” tab 1707 from the menu, the “shortcut” tab 1707 expands into a shortcuts menu 1711 from which the user may select various attributes for the shortcut.

In 17c, if the user selects the “applications” tab 1713 from the shortcuts menu 1711, the “application” tab 1713 expands into an applications menu 1715. In 17d, from the applications menu 1715, the user may select a persona to associate with the shortcut. In the case depicted, the user selects the “Work Persona Apps” menu item 1717, which launches the screen depicted in 17e from which the user is prompted to enter a password. After entry of the password, in 17f, the user is presented with a menu of applications 1719. In the case depicted, in 17g, the user selects the “Calendar” tab 1721 from the menu of applications 1719, which generates the application shortcut 1703. The resulting shortcut 1703, which preferably (but not necessarily) takes the place of the selected application icon, may be marked with a suitable indicia to indicate the persona it is associated with. Marking application icons with suitable indicia is described further herein above with respect to FIG. 10.

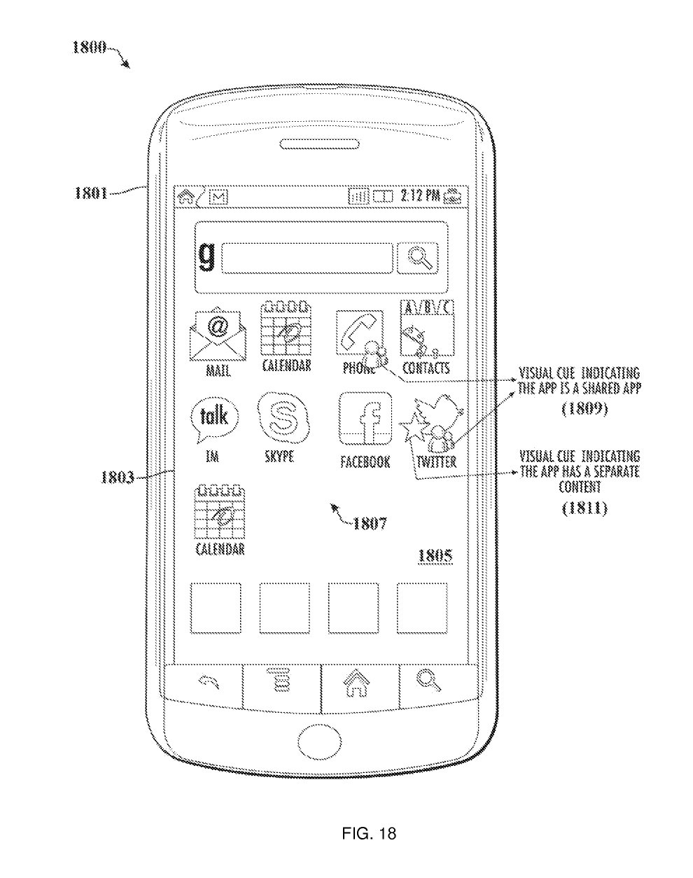

FIG. 18 illustrates another particular, non-limiting embodiment of a system 1800 and methodology for application distribution in accordance with the teachings herein. The system 1800 is depicted with respect to its implementation on a mobile device 1801 equipped with a display 1803. The illustrated embodiment includes a single desktop view 1805 that features a series of application icons 1807.

In the system 1800 depicted, application distribution is achieved through the use of shared applications. Shared applications are applications that can be used across all personas. A shared application behaves as a single instance application across all personas, meaning that any change of state made to the application in one persona applies instantly to the same application in another persona.

A shared application may have separate content or shared content. When the content is shared, the application content and view is typically identical. When the application content is separate, the view and content of the application is different. By way of example, an Angry Bird™ Star Wars® gaming application may be a shared application with separate content so that each persona may play Angry Birds™ Star Wars® but have a different score and be in a different stage in the game.

An application can be defined as a shared application either during installation or post-installation. A shared application may have shared content or separate content, and these features may be defined during installation or post-installation. Shared applications may or may not have a visual cue 1809 to indicate if they are shared across personas.

In the same manner, un-shared applications may or may not have a visual cue (not shown) to indicate if they are not shared across persona. Shared applications with separate content may or may not have a visual cue (e.g., visual cue 1811) to indicate that the shared application has a separate content. In the same manner, shared applications with shared content may or may not have a visual cue (not shown) to indicate that the shared application has shared content.

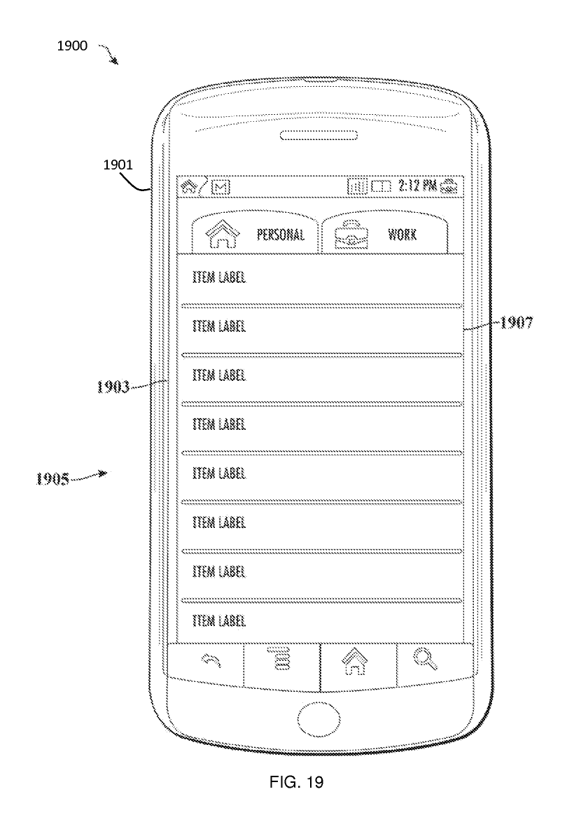

FIGS. 19-21 are screenshots illustrating a particular, non-limiting embodiment of a system 1900 through 2100 for application sharing in accordance with various embodiments. With reference to FIG. 19, the embodiment is depicted with respect to its implementation on a mobile device 1901 equipped with a display 1903. In the system depicted, when an application is properly selected (e.g., through a long press or other suitable means), a screen 1905 is generated containing a series of item labels 1907.

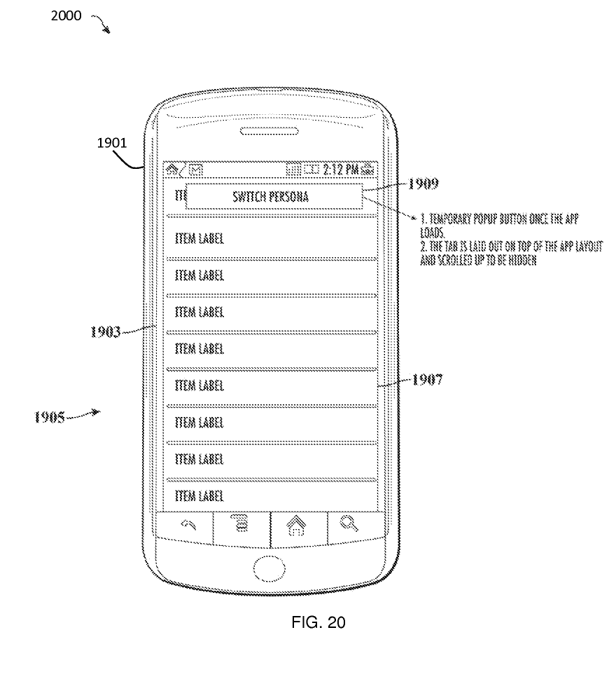

With reference to FIG. 20, the embodiment is depicted with respect to its implementation on a mobile device, such as mobile device 1901 equipped with a display, such as, display 1903. A temporary popup button 1909 appears once an application is loaded. The popup button 1909 is laid out on top of an application layout screen, such as, screen 1905 which contains a series of item labels 1907, and may be scrolled up to be hidden. This hiding is similar to the address bar hiding available in the Android™ browser. One skilled in the art will appreciate that this approach may work well in applications with linear or relative layouts, but may be inefficient in applications with absolute layout or graphic applications such as games where the content does not scroll.

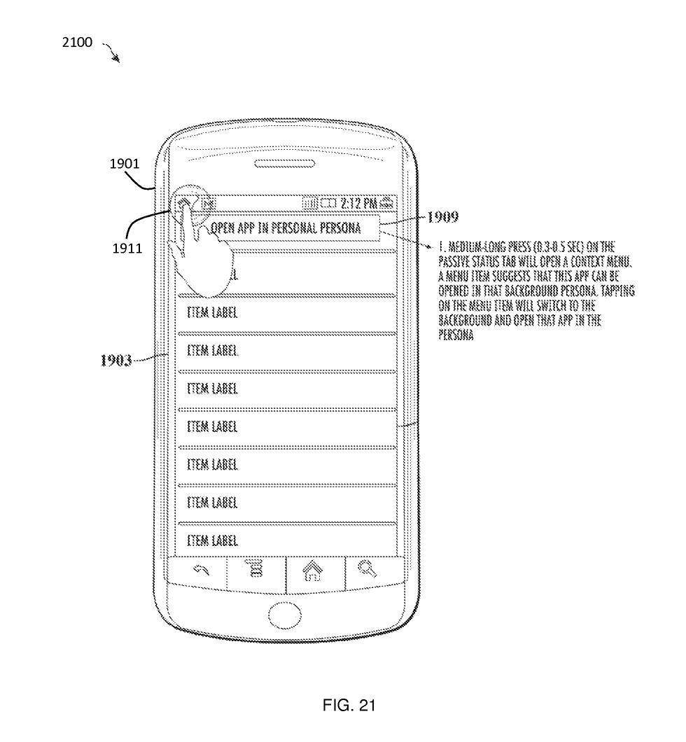

With respect to FIG. 21, the embodiment is depicted with respect to its implementation on a mobile device, such as mobile device 1901 equipped with a display, such as, display 1903. In the system 2100 depicted therein, a medium-long press 1911 (e.g., a press lasting 0.3-0.5 seconds) on a passive status tab will open a temporary popup button 1909 with a context menu. A menu item suggests that this application can be opened in that background persona. Tapping on the menu item will switch to the background and open that application in the persona.

Several modifications and variations are possible with respect to the systems and methodologies described above. While various embodiments been described with respect to their implementation on mobile communications devices, one skilled in the art will appreciate that the disclosed embodiments may also be implemented on various other mobile technology platforms including, but not limited to, book readers (such as Amazon's KINDLE® book reader), displays, and various types of mobile and other computers.

Various types of syncing may be performed in the systems and methodologies disclosed herein. Such syncing may be accomplished by implementing suitable syncing protocols, such as IMAP, CalDav, SyncML, and Microsoft Exchange, and may be performed for various data types, such as contacts, calendar events, emails, files, photos, and the like.

Syncing may occur with one persona acting as a sync server (i.e., a data provider) while the other persona acts as a sync client (i.e., a data consumer). The sync data may be filtered or modified by the syncing server (provider). Preferably, synced data is pulled by the client side from the server side, although it is also possible that the server side will push updates or new data, or revoke the data.

Synced data may be set in a way that, when used in a second persona, such synced data may activate actions in a first persona. For example, if a contact is synced from a first persona to a second persona, selecting to call the contact in the second persona may initiate the call in the first persona. Synced data may also be read-only in the second persona.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for sharing programs among a first persona and a second persona on a mobile technology platform equipped with a display, comprising:
providing a first software application for sharing among the first persona and the second persona;
in response to a user's launch of the first application in either the first persona or the second persona, starting the first application in a third persona; and
in response to the user's launch of the first application in either the first persona or the second persona, switching the user from a persona of origin to the third persona, wherein the persona of origin is the persona in which the user launched the first application, wherein the first persona and the second persona are defined as a set of user preferences associated with an operating system of the mobile technology platform.

2. The method of claim 1, wherein the third persona contains user preferences shared between the first persona and the second persona.

3. The method of claim 1, further comprising:
providing an indication to the user that a switch from the persona of origin to the third persona has occurred.

4. The method of claim 1, wherein the application is marked with an indicia to indicate that the launch or running of the first application will be undertaken in a different persona than the one the user is in when the first application is launched.

5. The method of claim 4, wherein the indicia is at least one of: border colors, logos, and status bar colors.

6. The method of claim 1, further comprising:
in response to exiting from the first application, switching the user back to the persona of origin.

7. The method of claim 1, wherein the launch of the first application will be undertaken with respect to the user preferences associated with the persona of origin.

8. The method of claim 1, further comprising:
in response to launching of a second application, switching the user back to the persona of origin.

9. The method of claim 1, wherein the first persona and the second persona have an associated first data store and an associated second data store, respectively.

10. The method of claim 9, wherein launching the application from the first persona binds the first data store to the third persona, and wherein launching the application from the second persona binds the second data store to the third persona.

11. The method of claim 9, wherein launching a second instance of the application from a launch persona while a first instance of the application is open in the persona of origin causes the first instance of the application to close and binds the second data store to the third persona.

12. The method of claim 9, wherein the third persona has a third data store associated with the third persona, wherein the third data store is shared between the first persona and the second persona.

13. The method of claim 12, wherein the first persona accesses the third data store via a first proxy, and wherein the second persona accesses the third data store via a second proxy.

14. The method of claim 13, wherein access to the third data store associated with the third persona is subject to a predefined access policy.

15. A non-transitory computer readable medium having stored thereon instructions for causing one or more processing units to execute the method according to claim 1.

16. A communication terminal, comprising:
a display;
a processing unit; and
a memory, the memory containing instructions that, when executed by the processing unit, configure the terminal to:
provide a first software application for sharing among the first persona and the second persona;
in response to a user's launch of the first application in either the first persona or the second persona, start the first application in a third persona; and
in response to the user's launch of the first application in either the first persona or the second persona, switch the user from a persona of origin to the third persona, wherein the persona of origin is the persona in which the user launched the first application, wherein the first persona and the second persona are defined as a set of user preferences associated with an operating system of the mobile technology platform.

17. The communication terminal of claim 16, wherein the third persona contains user preferences shared between the first persona and the second persona.

18. The communication terminal of claim 16, wherein the first persona and the second persona have an associated first data store and an associated second data store, respectively.

19. The communication terminal of claim 18, wherein the terminal is further configured to: launch the application from the first persona binds the first data store to the third persona, and wherein launching the application from the second persona binds the second data store to the third persona.

20. The communication terminal of claim 19, wherein the terminal is further configured to: launch a second instance of the application from a launch persona while a first instance of the application is open in the persona of origin causes the first instance of the application to close and binds the second data store to the third persona.

21. The communication terminal of claim 18, wherein the third persona has a third data store associated with the third persona, wherein the third data store is shared between the first persona and the second persona.

22. A method for sharing data among a first persona and a second persona on a mobile technology platform, the method comprising:
providing a first persona, a second persona, and a third persona, wherein each of the first persona, the second persona, and the third persona is associated with a first data store, a second data store, and a third data store, respectively; and
sharing the third data store between the first persona and the second persona, wherein the first persona and the second persona are defined as a set of user preferences associated with an operating system of the mobile technology platform.

23. The method of claim 22, wherein the first persona accesses the third data store via a first proxy, and wherein the second persona accesses the third data store via a second proxy.

24. The method of claim 22, wherein sharing the third data store between the first persona and the second persona is performed using any of: a shared file, a directory that is made visible or accessible in either the first persona or the second persona and by a suitable remote procedure call (RPC).

25. The method of claim 22, wherein the third data store includes global device settings for the mobile technology platform.

26. The method of claim 22, wherein the mobile technology platform is equipped with an operating system, and wherein program calls to read or modify settings in the operating system are redirected using proxy logic to a service in the third persona.

27. A non-transitory computer readable medium having stored thereon instructions for causing one or more processing units to execute the method according to claim 1.

28. A communication terminal, comprising:
a display;
a processing unit; and
a memory, the memory containing instructions that, when executed by the processing unit, configure the terminal to:
provide a first persona, a second persona, and a third persona, wherein each of the first persona, the second persona, and the third persona is associated with a first data store, a second data store, and a third data store, respectively; and
share the third data store between the first persona and the second persona, wherein the first personas and the second persona are defined as a set of user preferences associated with an operating system of the mobile technology platform.

29. The communication terminal of claim 28, wherein the first persona accesses the third data store via a first proxy, and wherein the second persona accesses the third data store via a second proxy.

30. The communication terminal of claim 28, wherein the third data store includes global device settings for the mobile technology platform.

31. The communication terminal of claim 28, wherein the mobile technology platform is equipped with an operating system, and wherein program calls to read or modify settings in the operating system are redirected using proxy logic to a service in the third persona.
